(19) United States
(12) Patent Application Publication
(10) Pub. No.: US 2023/0172331 A1
(43) Pub. Date: Jun. 8, 2023

(54) CASE

(71) Applicant: HOLOS PHARM S.A.G.L., Lugano (CH)

(72) Inventor: Giovanni Antonio GIANNOTTI, Lugano (CH)

(21) Appl. No.: 17/998,452

(22) PCT Filed: May 10, 2021
(86) PCT No.: PCT/IB2021/053940

§ 371 Date: Nov. 10, 2022

(30) Foreign Application Priority Data
May 13, 2020 (IT) 102020000010948

(51) Int. Cl. A45C 9/00; A45C 5/14; A45C 13/00; A45C 15/00; A45C 13/40; A45B 11/00; H04R 1/02; H04R 5/02; H04R 3/00; G06F 3/16

(52) U.S. Cl. CPC A45C 9/00; A45C 5/14; A45C 13/005; A45C 15/00; A45C 13/40; A45B 11/00; H04R 1/028; H04R 5/02; H04R 3/00; G06F 3/162; A45B 2200/1054; F25D 11/003

(57) ABSTRACT

A case configured to act as a support for a parasol, a rotatable table, or a parasol awning, includes a body, that has an upper face containing a central hole intended to house a first rod and two side holes, aligned on the central hole and intended to house two further rods.

The invention relates to a case with wheels, or a trolley, designed to act as a support for a parasol, a rotatable table, or for an awning.

### BACKGROUND OF THE INVENTION

From the prior art, cases provided with wheels or trolleys are known, intended to contain personal belongings that a user wishes to take on a journey with any means of transport.

On the other hand, cases with wheels are not known that, in addition to being able to contain personal belongings, can be used to convey parasols, a rotatable table and parasol awnings.

### SUMMARY OF THE INVENTION

The object of the present invention is to supply a case that is provided with wheels, which enables a user to easily convey a parasol, a rotatable table and/or a parasol awning and use the case to assemble and support said parasol and/or parasol awning, thus making the conveying and assembly of said parasol, said rotatable table and/or said parasol awning particularly simple and easy, that, without the help of the case according to the invention, are in general inconvenient to safely and efficiently convey and assemble.

The object of the invention is achieved with a case according to claim 1.

### BRIEF DESCRIPTION OF THE DRAWINGS

Further features and advantages of the invention will be apparent from the following description that is provided merely by way of non-limiting example, with reference to the attached drawings, in which:

FIG. 1 is a frontal prospective view of a case according to the invention:

FIG. 2 is a rear prospective view of the case in FIG. 1:

FIG. 3 is a raised view from the right of the case in FIG. 1;

FIG. 4 is a raised view from the left of the case in FIG. 1:

FIG. 5 is a prospective view of a case according to the invention that illustrates a first mode of use of the case, in which a parasol and a rotatable table are fitted to and supported on the case,

FIG. 6 is a prospective view of a case according to the invention that illustrates a second mode of use of the case, in which a parasol is fitted to and supported on the case, to which two adjacent angles of a parasol awning and a rotatable table are fixed:

FIG. 7 illustrates another mode of use of cases according to the invention, in which to and on two cases according to the invention a respective parasol is fitted and supported and to each parasol a corner of a parasol awning is fitted.

FIG. 8 illustrates the use of four cases according to the invention to assemble and support a parasol awning, each corner of the parasol awning being fixed to and supported on a respective case;

FIGS. 9, 10 and 11 illustrate stabilizing elements for stabilizing the case according to the invention and use thereof, to improve the stability of the case:

FIG. 12 illustrates schematically a further accessory of the case according to the invention, for thermoregulation of the internal space of the case;

FIG. 13 is an enlarged detail in FIG. 12.

### DETAILED DESCRIPTION

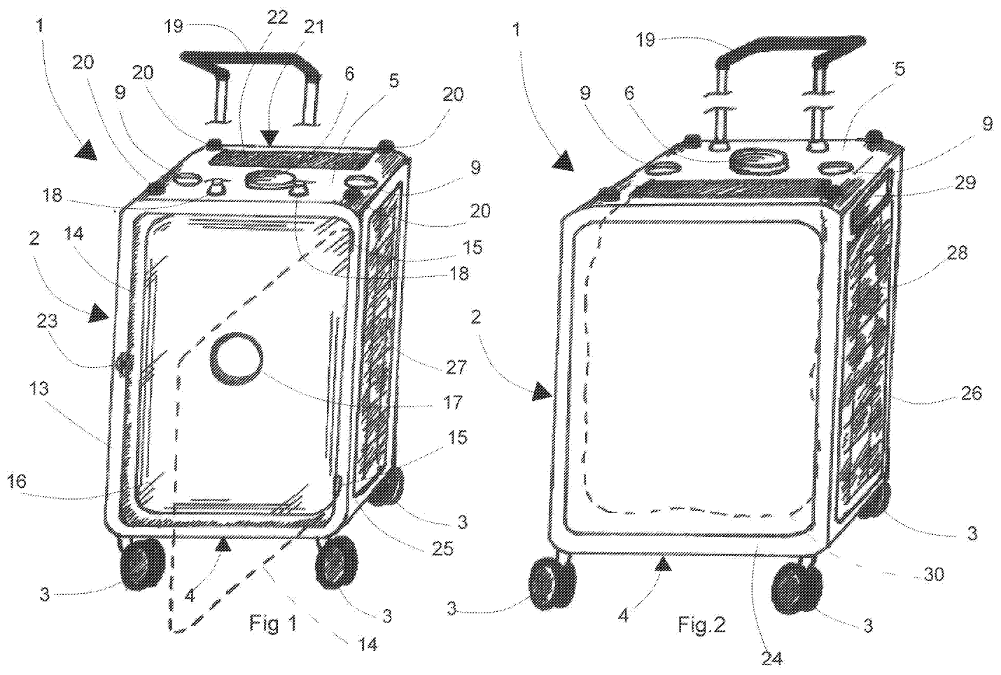

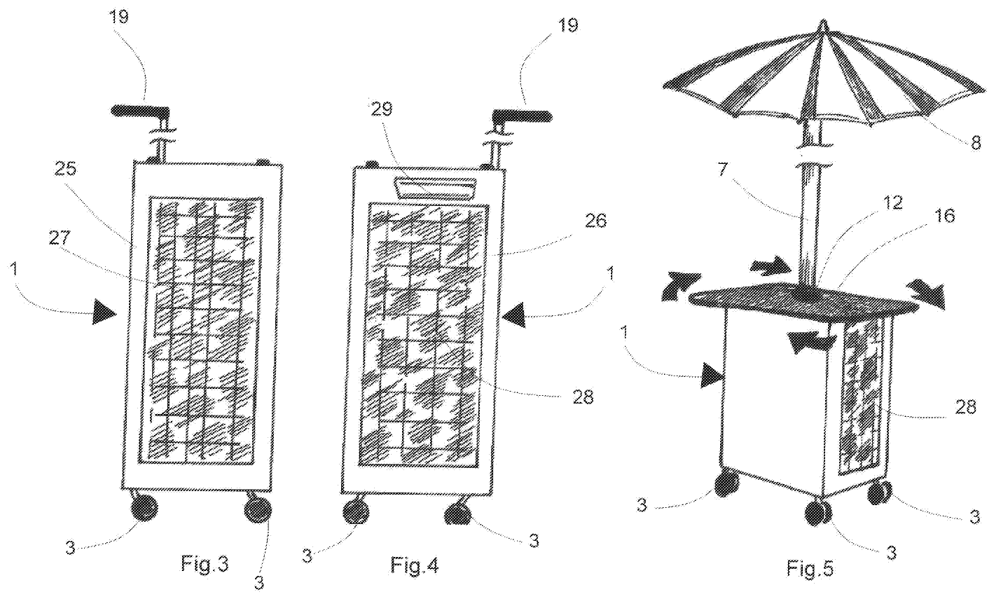

FIG. 1 shows, in a frontal prospective view, a case 1 according to the invention is provided with a body 2, for example parallelepiped-shaped, with a lower face 4 to which four wheels 3 are fixed, each of which is at an angle of the lower face 3. The wheels are used to move easily the case 1 on any running surface, like, for example, sand, gravel, a road or a pavement.

On an upper face 5 of the case 1, opposite the lower face 4, a central hole 6 is provided that is intended to house a first rod 7, for example a tubular rod, to which a parasol 8 (FIGS. 5, 6 and 7) can be fixed, or can act as a support and fixing element of a parasol awning 11 (FIG. 8).

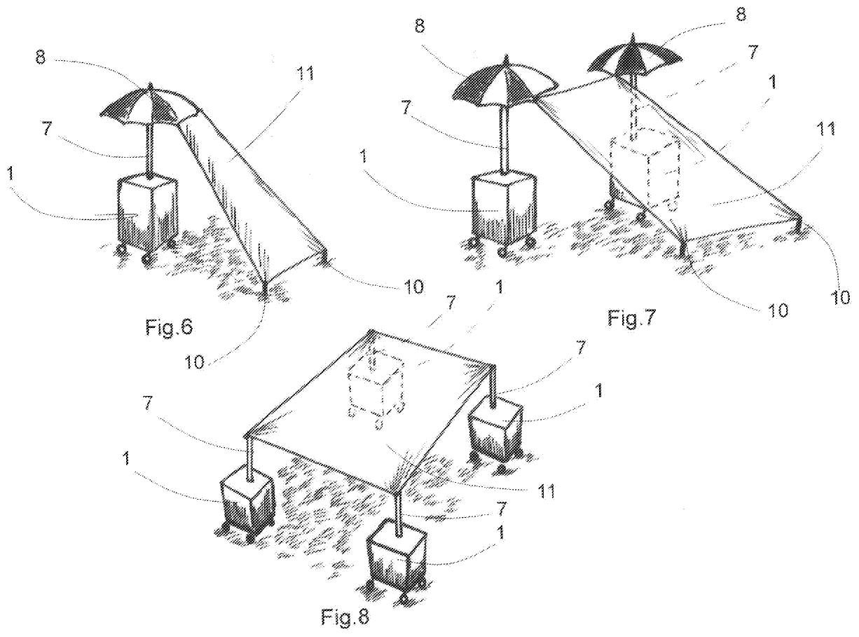

On the sides of the central hole 6, near two opposite sides of the upper face 5, two side holes 9 are provided that are aligned on the central hole 6 and intended to house two further rods 10, for example two further tubular rods, that are usable as support and fixing rods for supporting and fixing a parasol awning, 11 (FIGS. 6 and 7). The rods 10 can also be provided with a metal point for facilitating the insertion of the rods 10 into sand or soil.

The central hole 6 can be provided with a thread to tighten therein a lock nut 12 (FIG. 5) that is used to lock the first rod 7, to adjust the height of the parasol 8, with respect to the upper face 5 of the case 1.

A front face 13 of the case 1 is provided with a door 14 that can rotate around a pair of hinges 15, to permit access to an internal space of the case 1 in which compartments can be obtained for housing, for example, a refrigerator, an inverter and rechargeable lithium batteries, or supercapacitors, for supplying the refrigerator and for recharging mobile phones, the parasol, the awning, and other objects such as, for example, foldable chairs.

The door 14 is provided with a safety lock 23.

Instead of lithium batteries, so-called supercapacitors can be used, i.e. high capacity capacitors that enable electric energy to be stored and released as a battery, but have the advantage of enabling chargeable batteries to be charged more rapidly and energy to be released more rapidly, ensuring performance that is significantly greater than batteries with the same density of electric charge.

To the front face 13 of the case 1, or to a rear face 24 of the case 1, opposite the front face 13, a stiff container or a net container can be fixed removably, in which the parasol 8, the parasol awning 11, foldable chairs and other objects can be placed, if it is not possible to place the parasol awning 11, foldable chairs and other object, for example because of lack of space, in the internal space of the case 1.

In the internal space, near the door 14, a table 16 is wedgeable, provided with a central opening 17, for example of circular shape. The table 16 can be extracted from the internal space and be fitted to the upper face 5 to act as a resting plane or table. The round central opening 17 is used to permit the transit of the first rod 7, when the table 16 is fitted to the upper side 5 of the case 1. Further, the central opening 17 is used to facilitate the extraction of the table 16 from die internal space of the case 1, enabling a user to grasp the table 16 at the central opening 17.

On the upper face 5, a pair of holes 18 is further provided in which an extractable handle 19 is slidable for conveying the case 1.

The holes 18 are not aligned on the central hole 6, but are moved near the front face 13, such that the extractable handle 19 does not constitute an obstacle to fitting the parasol 8.

At die corners of the upper face 5, resting elements 20 are provided, for example rubber elastic resting elements, on which the table can be rested 16. The resting elements 20 have a height that is greater than the thickness of the lock nut 12 such that the lock nut 12 does not hinder rotation of the table 16.

Lastly, in the upper face 5 an opening 21 is lastly provided, closed by a cover 22. The opening 21 gives access to a further internal space into which a bag 30 is insertable into which sand, gravel or earth can be introduced to give the case 1 ballast so as to grant stability to the case 1 in the event of wind when the parasol 8 is fitted to the case 1 and opened. The internal space can be made accessible by a door placed on a rear face 24 of the case 1, opposite the front face 13.

Instead of the bag 30, a receptacle can be inserted into the aforesaid further internal space, for example a can suitable for containing water, which can act as ballast to give stability to the case 1. The receptacle can be provided with a tap, to enable the water contained therein to be removed and to empty the receptacle.

On a first side face 25 of the case 1 and on a second side face 26 of the case 1, opposite the first side face 25, a first photovoltaic panel 27 and a second photovoltaic panel 28 can be arranged, respectively to supply electric energy to recharge the lithium batteries, or the supercapacitors.

On the first side face 25, or on the second side face 26, an openable and reclosable ash tray 29 can be further provided.

In FIG. 5, use is illustrated of a case 1 according to the invention, to fit a parasol 8 and the table 16.

First, the first rod 7 is extracted from the central hole 6. Then, the table 16 is extracted from the internal space of the case 1 and arranged on the resting elements 20, so that the central hole 17 of the table 16 is aligned on the central hole 6 of the upper face 5 and on the lock nut 12. It is then passed into the central round hole of the table 17 and in the central hole 6 the first rod 7 and is locked in position by the lock nut 12, so that it protrudes from the upper face 5 fora desired height. Lastly, the parasol 8 is fixed to the first rod 7. The protrusion of the first rod 7 and thus of the parasol 8 with respect to the upper face 5 of the case 1 can be varied by acting on the lock nut.

In FIG. 6, use is illustrated of a case 1 according to the invention for fitting a parasol awning 11.

In order to fit the parasol awning 11, the further rods 10 are extracted from the side holes 9 of the upper face 5 of the case 1 and a first end thereof, for example provided with a metal point, is fixed into the soil or into the sand.

Two adjacent corners of the parasol awning 11 are fixed, by fixing elements with which the parasol awning 11 is provided, to a second end of the further rods 10, opposite with respect to said first end.

The remaining two corners of the parasol awning 10 are fixed to rings on the parasol 8 that has been previously fitted to the case S.

In FIG. 7, use is illustrated of two cases 1 according to the invention for fitting a parasol awning 11.

In order to fit the parasol awning 11, two rods 10 are extracted from the side holes 9 of one of the cases 1 and a first end thereof, for example provided with a metal point, is fixed into the soil or sand.

Two adjacent angles of the parasol awning 11 are fixed, by fixing elements with which the parasol awning 11 is provided, to a second end of the rods 10, opposite to said first end.

The remaining two corners of the parasol awning 11 are fixed to rings provided on two parasols 8, each of which has been previously fitted to a respective case 1.

FIG. 8 shows use of four cases 1 according to the invention for fitting a parasol awning 11.

Above all, the first rods 7 of each case 1 are fixed in position in the respective central holes 6 of the upper faces 5 of the cases 1 by the respective kick nuts 12. Subsequently, each corner of the parasol awning 11 is fixed to a respective first rod 7, as is shown in FIG. 8. The height from the soil of the parasol awning 11 can be adjusted by modifying the height of the first rods 7 with respect to the cases 1.

In FIGS. 8, 9, 10, stabilizing elements are illustrated of a variant of the case 1 according to the invention, the aim of which is to improve the stability of the case 1 in the event of wind when the parasol S is fitted to the case 1 and open, or when the case 1 is used to fit a parasol awning 11, without any need to provide the case 1 with bulk.

The stabilizing elements consist of four further rods 31, a first end 32 of which is hinged on corner zones of the lower face 4 of the case 1. A second end of each rod 31, opposite with respect to the first end 32, is provided with a peg 33 which is slidable ink a direction that is perpendicular to said lower face 4, so as to be planted in a soil on which the case 1 is rested.

The further rods 31 can be rotated in an extended position, shown in FIG. 9, in which they increase, even doubling, the rest surface of the case 1, so as to increase significantly the stability thereof that can be further improved by inserting the pegs 33 into the soil.

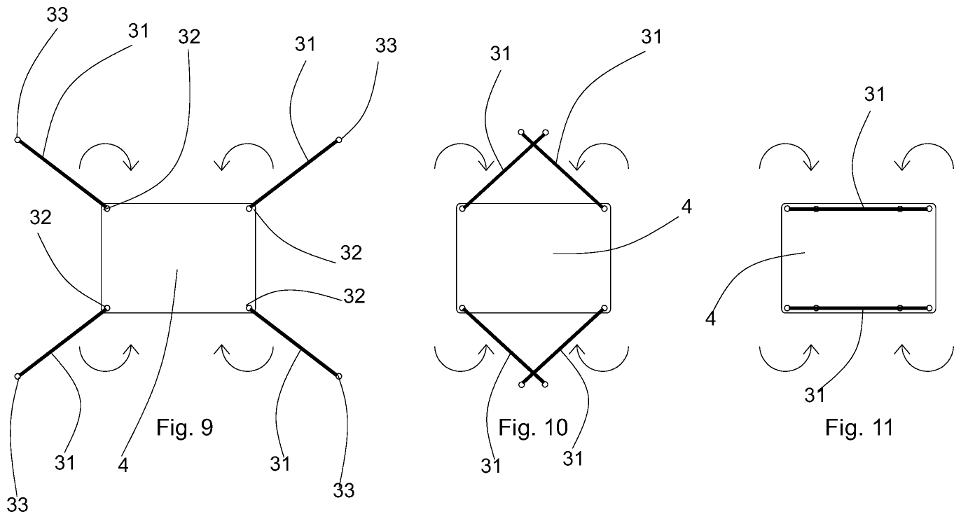

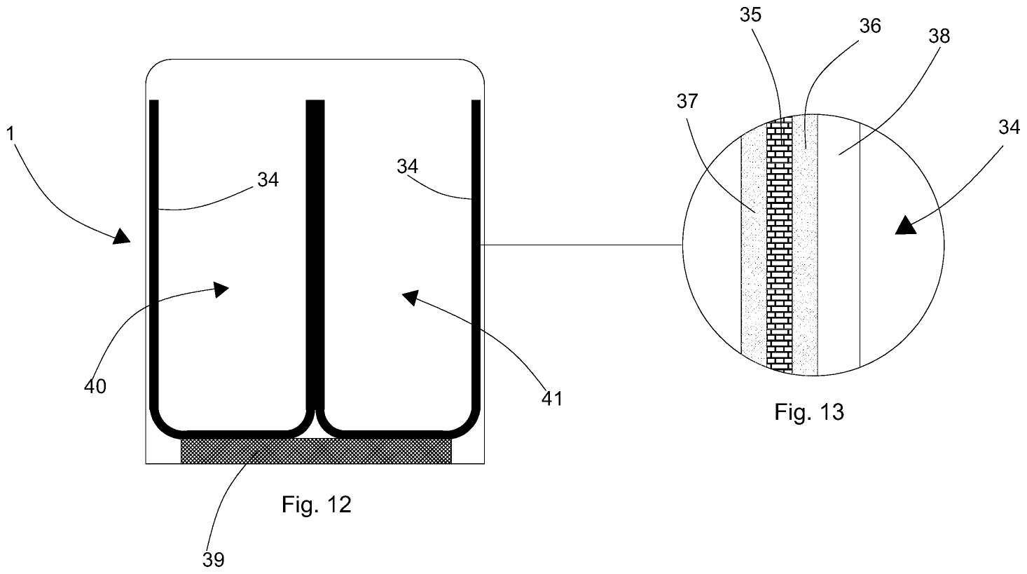

The further rods 31 can be rotated in a retracted position, as shown in FIGS. 10 and 11, in which (FIG. 11) they are aligned in pairs parallel to the greater sides of the lower face 4 of the case 1.

The further rods 31 are so hinged as to be able to rotate without interfering with the wheels 3 of the case 1.

In FIG. 5, a further version of the case 1 according to the invention is illustrated schematically, in which a system for heating, or cooling, the internal space of the case 1 is provided.

The heating or cooling system consists of a covering 34 of the internal space of the case 1.

The covering 34 consists of a multilayer material that includes a layer 35 consisting of a plurality of Peltier cells, enclosed between a pair of layers 36 and 37 of a heat conducting material and an outer covering layer 38.

By applying a potential difference to the Peltier cells of the layer 35, a heat transfer is obtained from the internal space of the case 1 to the exterior or vice versa, depending on the sign of the applied potential difference.

In this manner, cooling or heating can be obtained of the internal space, to cool or heat food contained in said internal space.

The heat transfer from the internal space to the exterior of the case 1, or vice versa, can be made more efficient by providing a radiator 39 arranged on the bottom 4 of the case 1, in contact with the covering 34.

In a yet further variant of the case 1, the internal space can be divided into a first compartment 40 and into a second compartment 41, both covered with the covering 34, so as to be able to obtain a heat transfer between the two compartments, so that one of them, for example the first compartment 40, can act as a refrigerated compartment, whilst the second compartment 41 can act as a heated compartment.

Each wheel 3 of the case 1 according to the invention can include a tyre, so as to be able to vary the inflation pressure of the tyre, to adapt said deformability to the nature of the surface on which the case 1 rests and is moved. For example, a high inflation pressure is suitable for moving the case 1 on hard surfaces, such as for example a cement or asphalt surface. On the other hand, a low pressure is suitable for moving the case on yielding or uneven surfaces like sand, loose or uneven soil.

In order to adapt easily the inflation pressure of the wheels 3 to the type of surface on which the case 1 has to be moved, the case 1 is provided with a system for varying the inflation pressure with a compressor, provided with connecting elements for connecting to the tyres of the wheels 3, configured so as to enable the compressor to increase or decrease the inflation pressure of the tyres.

The compressor is supplied by the lithium batteries or the supercapacitors with which the case 1 is provided.

The case 1 according to the invention can be provided with an armoured container, for example made of manganese alloy, embedded deeply into the structure of the case so that it is not possible to extract the case without destroying the entire structure. Even after the container has been extracted, the toughness of the manganese alloy will make it very difficult to open the container. The armored container can be used to house valuables. Further, the armoured container can be provided with a satellite localization system with an independent supply, which via specific software, usable on all smartphone and PCs, will show in real time the position of the case, making the theft thereof difficult and making locating the case easy in the event of theft or loss.

The case 1 according to the invention can be provided with a stereo speaker with a Bluetooth Interface. Any smartphone or the like can easily interface with the speaker and reproduce multimedia contents with good audio quality.

Lastly, the case 1 can be provided with a USB Host socket designed to charge the electronic devices using the lithium batteries or the supercapacitors of the case 1, the USB Host socket being connected electrically to the lithium batteries or to the supercapacitors.

1. Case configured to act as a support for a parasol, a rotatable table, or a parasol awning, wherein the case includes a body, that has an upper face, in which a central hole intended to house a first rod and two side holes, aligned on the central hole and intended to house two further rods are provided, and a lower face to which four wheels are fixed, each of which is arranged at an angle of the lower face.

2. Case according to claim 1, wherein said first rod is configured so as to be able to support a parasol and/or a parasol awning and said further rods are configured to support said parasol awning.

3. Case according to claim 1, wherein said first rod and said further rods have a tubular shape, said further rods being provided, at a respective end, with a metal point that is suitable for facilitating the insertion of said end into soil.

4. Case according to claim 1, wherein said body is provided with an internal space that is accessible from a front face of said body through a door that is rotatable around a pair of hinges and is provided with a safety lock.

5. Case according to claim 4, wherein in said internal space a rotatable table is fixed removably that is provided with a round central opening, said rotatable table being able to be arranged on said upper face above four resting elements arranged at the corners of said upper face, said round central opening being aligned with said central hole is rested on said resting elements.

6. Case according to claim 1, further including a lock nut that can be fixed in said central hole, in particular by a threaded coupling, said lock nut being configured to enable said first rod to be positioned and locked at said central hole.

7. Case according to claim 4, including a further internal space into which a bag can be inserted that is suitable for containing sand, rocks or gravel, or a receptacle that is suitable for containing a liquid, said sand, rocks or gravel, or said liquid acting as ballast to stabilize said case.

8. Case according to claim 7, wherein said further internal space is accessible through an opening made in said upper face and reclosable with a cover, or through a door made in a rear face of said body, opposite with respect to said front facet.

9. Case according to claim 1, wherein on a first side face of said body a first photovoltaic panel is arranged and/or on a second side face of said body a second photovoltaic panel is arranged.

10. Case according to claim 9, wherein said body is provided with an internal space that is accessible from a front face of said body through a door, wherein in said internal space of said body a refrigerator is arranged that can be supplied by lithium batteries, or by supercapacitors, which are also arranged in said internal space, wherein said lithium batteries, or said supercapacitors, can be recharged by said first photovoltaic panel and/or said second photovoltaic panel.

11. Case according to claim 8, wherein to said front face or to said rear face a container is fixed removably that is suitable for containing a parasol, a parasol awning, folding chairs and other objects.

12. Case according to claim 1, wherein said body is provided with stabilizing elements including four further rods a first end of which is hinged on corner zones of the lower face of said body.

13. Case according to claim 12, wherein a second end of each further rod, opposite the first end, is provided with a peg that is slidable in a direction that is perpendicular to said lower face.

14. Case according to claim 1, wherein an internal space of the case is provided with a covering consisting of a multilayer material including a layer consisting of a plurality of Peltier cells.

15. Case according to claim 14, wherein said layer consisting of Peltier cells is enclosed between a pair of layers of a heat conducting material, the covering being further provided with an outer covering layer.

16. Case according to claim 14, wherein said internal space is divided into a first compartment and into a second compartment, both covered with said multilayer material.

17. Case according to claim 14, wherein a radiator is arranged on the bottom of the case, in contact with the covering.

18. Case according to claim 1, wherein each wheel includes a tyre, wherein the case is provided with a system for varying the inflation pressure of each tyre including a compressor and connecting elements for connecting the compressor to the tyres of the wheels, said connecting elements being configured so as to enable the compressor to increase or decrease the inflation pressure of the tyres.

19. Case according to claim 1, wherein the case is provided with an armoured container so integrated into a structure of the case that it is not possible to extract the armoured container without destroying said structure.

20. Case according to claim 19, wherein said armoured container is provided with a satellite localization system.

21. Case according to claim 1, wherein the case is provided with a stereo acoustic box with a Bluetooth interface.

22. Case according to claim 10, wherein the case is provided with a USB Host socket connected electrically to said lithium batteries or to said supercapacitors.
